(19) United States
(12) Patent Application Publication
(10) Pub. No.: US 2011/0188632 A1
(43) Pub. Date: Aug. 4, 2011

(54) MULTIPLE PLANE MULTI-INVERSE FAN-BEAM DETECTION SYSTEMS AND METHOD FOR USING THE SAME

(76) Inventors: Geoffrey Harding, Hamburg (DE); Stephan Olesinski, Hamburg (DE); Dirk Kosciesza, Pinneberg (DE); Helmut Rudolf Strecker, Hamburg (DE)

(21) Appl. No.: 12/699,528

(22) Filed: Feb. 3, 2010

(51) Int. Cl. G01N 23/201; G21K 1/02

(52) U.S. Cl. 378/86; 378/147

(57) ABSTRACT

A detection system includes a multi-focus radiation source configured to generate X-ray radiation and a primary collimator defining a first row of apertures and a second row of apertures. The first row of apertures forms first X-ray beams within a first plane from the X-ray radiation, and the second row of apertures forms second X-ray beams within a second plane from the X-ray radiation. The first plane is different than the second plane. The detection system further includes a scatter detector including a first row of scatter detector elements and a second row of scatter detector elements. The first row of scatter detector elements is configured to detect scattered radiation from the first X-ray beams, and the second row of scatter detector elements is configured to detect scattered radiation from the second X-ray beams.

### BACKGROUND OF THE INVENTION

1. Field of the Invention

The embodiments described herein relate generally systems for detecting an object and, more particularly, to X-ray diffraction imaging systems.

2. Description of Related Art

At least some known detection systems are used at travel checkpoints to inspect containers, such as carry-on luggage and/or checked luggage, for concealed contraband, such as weapons, narcotics, and/or explosives. At least some such detection systems include X-ray imaging systems. An X-ray imaging system includes an X-ray source that transmits X-rays through a container towards a detector. An output of the detector is processed to identify a set of objects and/or materials within the container. In addition, at least some known detection systems include X-ray diffraction imaging (XDi) systems. At least some known XDi systems use inverse fan-beam geometry (a large source and a small detector) and a multi-focus X-ray source (MFXS) to detect objects and/or materials. Further, some known XDi systems provide an improved discrimination of materials, as compared to that provided by other known X-ray imaging systems, by measuring d-spacings between lattice planes of micro-crystals in materials. X-ray diffraction may also yield data from a molecular interference function that may be used to identify other materials, such as liquids, in the container.

At least some known detection systems have a Multiple Inverse Fan Beam (MIFB) XDi topology. The conventional MIFB topology directs X-ray beams from a certain focus point of an MFXS via a Multi Point Primary Collimator (MuPiC) onto a fixed array of target points at a detector plane. The MuPiC includes a single row of apertures that generate primary pencil beams directed to each target point in the detector plane. The primary beams propagate in an X-Y plane through the container, and interactions between the primary beams and the container induce coherent scattering. Scattered rays of radiation pass through a Fixed Angle Secondary Collimator (FASC), which collimates the scattered rays to make a constant dihedral scatter angle θ to the X-Y plane. Thus, the scattered rays that are incident on coherent scatter detectors satisfy the conditions for fixed angle, energy dispersive X-ray diffraction. The momentum transfer p is given by the following relationship:

$$p = \frac{E}{hc} \cdot sin ( \frac{θ}{2} ) , \qquad ( Equation 1 )$$

where E is photon energy, h is Planck's constant, c is the speed of light, and θ is a scatter angle. The energy spectrum of the scatter rays, after appropriate processing, corresponds to an X-ray diffraction (XRD) profile of a material lying in a sensitive volume of the container; namely, intersection regions of primary beam paths and scattered ray paths. The only moving component of a known XDi detection system is a conveyor belt that transports the container in a Z-direction that is perpendicular to an X-Y plane.

There is unfortunately an inter-detector cross-talk issue in the conventional MIFB topology. Cross-talk is produced when a scattered ray from a primary beam generated, e.g., by an I-th source focus directed to a J-th target point, is received at a J±1-th transmission detector element. Conventionally, in order to minimize cross-talk, a separation between transmission detector elements can be increased. However, increasing the spacing between transmission detector elements has at least two negative consequences. First, a total number of MIFB transmission detector elements decreases, which adversely affects a scatter signal. Second, a near detector intersection point of inverse fan beams to neighboring target points is moved closer to an X-ray multisource, which ultimately leads to container regions being missed during a scan.

As such, it is desirable to increase a spacing between detector elements without decreasing a number of detector elements. Further, it is desirable to increase a spacing between detector elements without moving near detector intersection points closer to a radiation source.

### BRIEF SUMMARY OF THE INVENTION

In one aspect, a detection system is provided. The detection system includes a multi-focus radiation source configured to generate X-ray radiation and a primary collimator defining a first row of apertures and a second row of apertures. The first row of apertures forms first X-ray beams within a first plane from the X-ray radiation, and the second row of apertures forms second X-ray beams within a second plane from the X-ray radiation. The first plane is different than the second plane. The detection system further includes a scatter detector including a first row of scatter detector elements and a second row of scatter detector elements. The first row of scatter detector elements is configured to detect scattered radiation from the first X-ray beams, and the second row of scatter detector elements is configured to detect scattered radiation from the second X-ray beams.

In another aspect, a method for detecting an object is provided. The method includes generating X-ray radiation from a radiation source, forming the X-ray radiation into first X-ray beams within a first plane and second X-ray beams within a second plane different than the first plane, and detecting the first X-ray beams at a first row of transmission detector elements of a transmission detector and the second X-ray beams at a second row of transmission detector elements of the transmission detector.

In yet another aspect, a primary collimator for use with an X-ray detection system is provided. The primary collimator defines a first row of apertures within a first plane and a second row of apertures within a second plane different than the first plane. The first row of apertures is configured to form first X-ray beams within the first plane, and the second row of apertures is configured to form second X-ray beams within the second plane.

By providing a multiple plane, such as a dual plane, multi-inverse fan beam topology, the embodiments described herein enable adjacent detector elements to be placed arbitrarily close to one another in a lengthwise (Y) dimension, while minimizing or eliminating inter-detector cross-talk.

### BRIEF DESCRIPTION OF THE DRAWINGS

FIGS. 1-11 show exemplary embodiments of the system and method described herein.

FIG. 1 is a schematic view, in an X-Y plane, of an exemplary detection system generating pencil beams.

FIG. 2 is a schematic view, in the X-Y plane, of the detection system shown in FIG. 1 generating inverse fan beams from the pencil beams shown in FIG. 1.

FIG. 3 is a schematic view, in an X-Z plane, of the detection system shown in FIGS. 1 and 2.

FIG. 4 is a schematic view, in a Y-Z plane, of an exemplary primary collimator that may be used with the detection system shown in FIGS. 1-3.

FIG. 5 is a schematic view, in a Y-Z plane, of an exemplary transmission detector that may be used with the detection system shown in FIGS. 1-3.

FIG. 6 is a schematic view, in the X-Z plane, of an alternative detection system.

FIG. 7 is a schematic view, in a Y-Z plane, of an exemplary primary collimator that may be used with the detection system shown in FIG. 6.

FIG. 8 is a schematic view, in the Y-Z plane, of an alternative primary collimator that may be used with the detection system shown in FIG. 6.

FIG. 9 is a schematic view, in the Y-Z plane, of an exemplary transmission detector that may be used with the detection system shown in FIG. 6.

FIG. 10 is a schematic view, in the Y-Z plane, of an alternative transmission detector that may be used with the detection system shown in FIG. 6.

FIG. 11 is a flowchart of an exemplary method that may be used with the detection system shown in FIGS. 1-5 and/or the detection system shown in FIGS. 6-10.

### DETAILED DESCRIPTION OF THE INVENTION

A detection system having a multiple plane, such as a dual plane, multi-detector inverse fan beam (MIFB) 3rd Generation X-ray Diffraction Imaging (XDi) topology is described herein. The embodiments described herein allow neighboring detector elements to be placed arbitrarily close to each other in a lengthwise (Y) direction, while reducing inter-detector cross-talk that is present in conventional MIFB systems. The embodiments described herein can be considered a “Hi-Fi MIFB” detection system. The Hi-Fi MIFB detection system minimizes cross-talk whilst increasing a total detector signal, thus, improving a detection rate and/or a false alarm rate. Moreover, the embodiments described herein simplify technological realization of a secondary collimator.

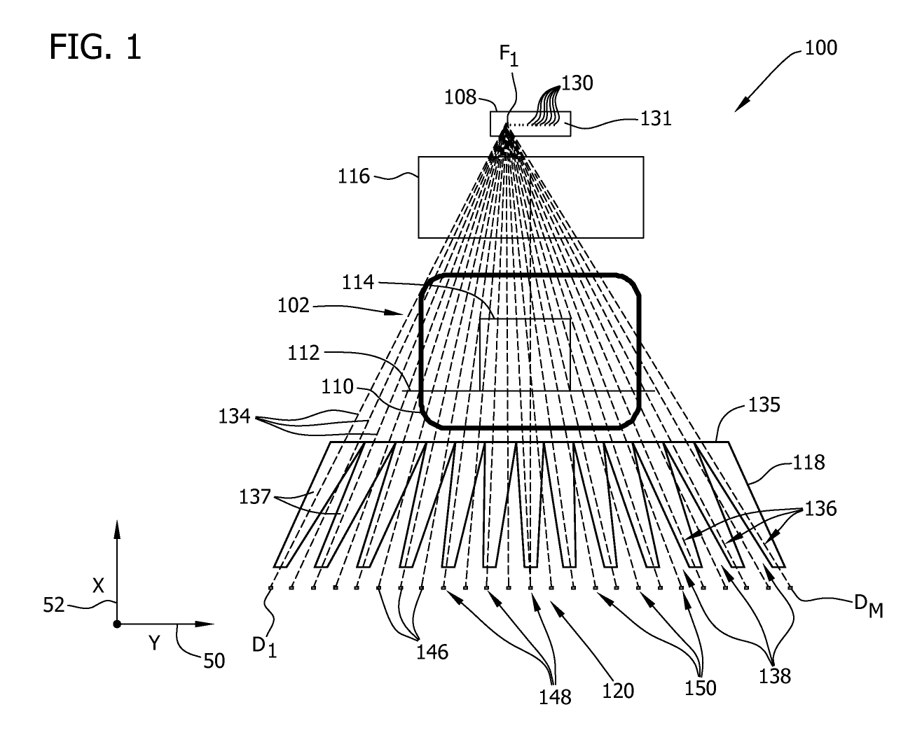

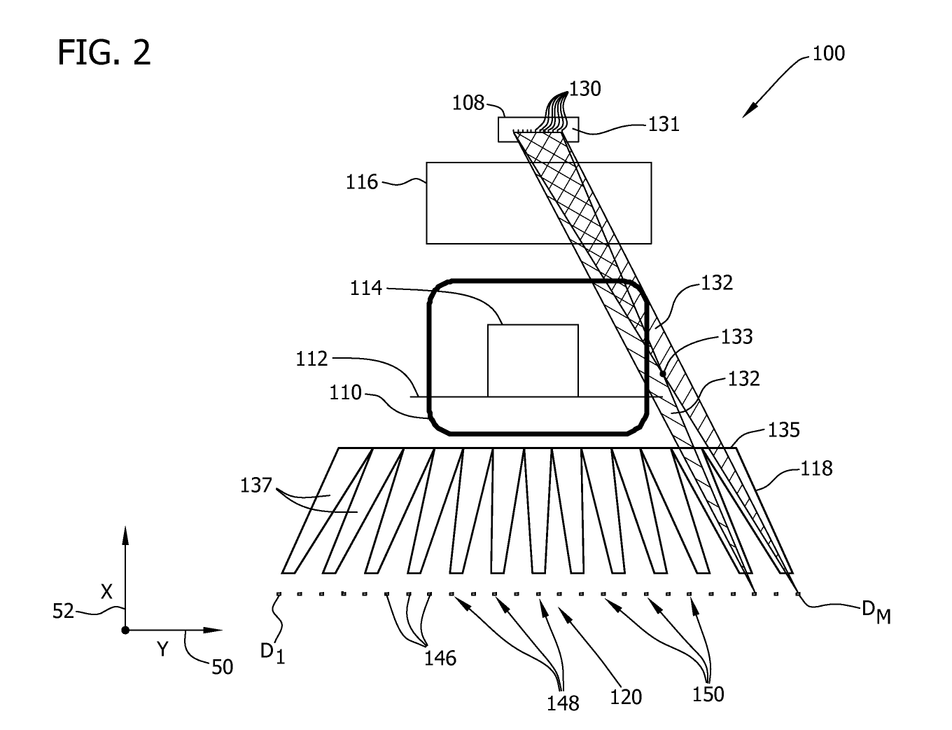

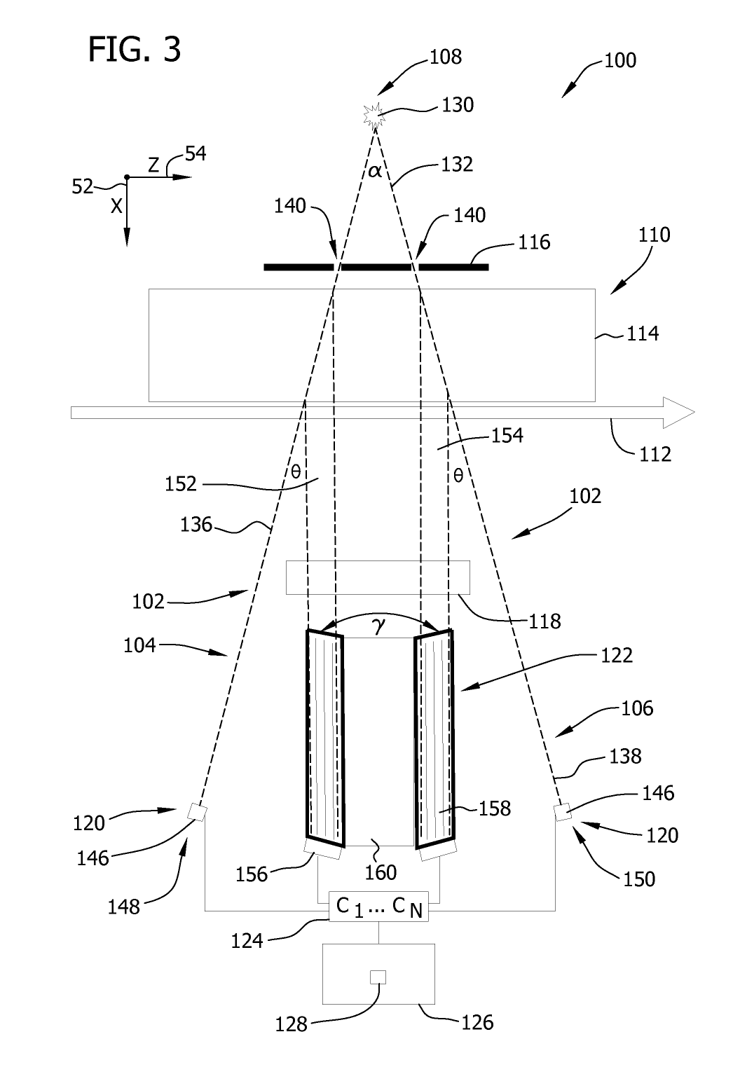

FIG. 1 is a schematic view, in an X-Y plane, of an exemplary detection system 100 generating primary beams 102. FIG. 2 is a schematic view, in the X-Y plane, of detection system 100 generating inverse fan beams 132 from primary beams 102. FIG. 3 is a schematic view, in an X-Z plane, of detection system 100. In contrast to conventional inverse fan-beam (IFB) systems, detection system 100 generates primary beams 102 that occupy more than one plane, namely a first plane 104 and a second plane 106, which are oriented at an angle a to each other and intersect at a radiation source 108. Although FIG. 3 shows detection system 100 having angle a that is substantially equal to twice a scatter angle θ, it should be understood that angle α may have any suitable value as long as a scatter detector does not detect or receive any radiation from an adjacent set of primary beams.

Referring to FIGS. 1-3, in the exemplary embodiment, detection system 100 is a multi-detector inverse fan beam X-ray diffraction imaging (MIFB XDi) system that includes radiation source 108, an examination area 110, a support 112 configured to support an object 114, a primary collimator 116, and at least one secondary collimator 118. Detection system 100 also includes two types of detectors, namely, at least one transmission detector 120 and at least one scatter detector 122. Transmission detector 120 is configured to detect primary beams 102 after passing through object 114, and scatter detector 122 is configured to detect coherent X-rays scattered by an interaction of primary beams 102 with object 114.

One or more transmission detectors 120 and one or more scatter detectors 122 are each in electronic communication with a number of channels 124, for example, N number of channels C₁, . . . C_{N}, wherein N is selected based on the configuration of detection system 100. Channels 124 electronically communicate data collected by transmission detector 120 and scatter detector 122 to a control system 126. In the exemplary embodiment, control system 126 combines an output from transmission detector 120 and an output from scatter detector 122 to generate information about object 114 and/or contents of object 114 positioned within examination area 110. For example, but not by way of limitation, control system 126 may generate multi-view projections and/or section images of object 114 in examination area 110 that identify a location in object 114 of specific materials detected by XDi analysis.

In the exemplary embodiment, control system 126 includes a processor 128 in electrical communication with transmission detector 120 and scatter detector 122. Processor 128 is configured to receive from scatter detector 122 output signals representative of detected X-ray quanta and to generate a distribution of momentum transfer values, x, from a spectrum of energy, E, of X-ray quanta within scattered radiation detected by scatter detector 122. As used herein, the term “processor” is not limited to integrated circuits referred to in the art as a processor, but broadly refers to a computer, a microcontroller, a microcomputer, a programmable logic controller, an application specific integrated circuit, and any other suitable programmable circuit. The computer may include a device, such as a floppy disk drive, a CD-ROM drive and/or any suitable device, for reading data from a suitable computer-readable medium, such as a floppy disk, a compact disc-read only memory (CD-ROM), a magneto-optical disk (MOD), or a digital versatile disc (DVD). In alternative embodiments, processor 128 executes instructions stored in firmware.

Referring to FIGS. 1-3, radiation source 108 is a multi-focus X-ray source (MFXS). More specifically, in the exemplary embodiment, radiation source 108 is capable of emitting X-ray radiation sequentially from a plurality of focus points 130 distributed along radiation source 108 in a direction substantially parallel to a Y-axis 50, which is perpendicular to an X-axis 52 and a Z-axis 54. A lengthwise direction is oriented along Y-axis 50, and a widthwise direction is oriented along Z-axis 54. Radiation source 108 includes any suitable number of focus points 130 that enable detection system 100 to function as described herein. Further, in the exemplary embodiment, radiation source 108 is configured to emit an X-ray fan beam 132 from each focus point 130. Each fan beam 132 is directed at transmission detector 120. Further, adjacent fan beams 132 intersect at crossing points 133.

In the exemplary embodiment, crossing points 133 are each located above a top edge 135 of secondary collimator 118. As such, separate secondary collimators 118 can be used for each fan beam 132, although secondary collimator 118 is illustrated as one piece with several portions 137, wherein each portion 137 collimates a respective fan beam 132. In contrast, in known XDi systems that generate inverse fan beams, crossing points are located at or just below a top edge of a secondary collimator, which dose not allow separate secondary collimators to be use because side walls of the separate secondary collimators would prevent at least some of the pencil beams in the fan from being detected at a scatter detector.

Referring to FIGS. 1 and 2, primary beams 102 in the form of a MIFB are projected along X-axis 52 in the X-Y plane. In one embodiment, radiation source 108 emits radiation sequentially from focus points 130. More specifically, radiation source 108 includes an anode 131 and a plurality of focus points 130 arranged along a length of the anode collinear with Y-axis 50. Each focus point 130 is sequentially activated to emit a respective X-ray fan beam 132. For example, focus point F₁ emits primary beams 102 as an MIFB that extends between and is detected by detector element D₁ through and including detector element D_{M} and includes a plurality of pencil beams 134 as each primary beam 102. Primary collimator 116 is configured to select from the radiation emitted at each focus point 130, primary beams 102 that are directed to a series of convergence points regardless of which focus point 130 is activated. Primary beams 102 are shown in FIG. 1 with each primary beam 102 emitted from a focus point F₁ directed to a corresponding convergence point positioned along a line parallel to Y-axis 50.

Primary collimator 116 is configured to form primary beams 102 in at least two planes. In the exemplary embodiment, primary collimator 116 is configured to form primary beams in first plane 104 and second plane 106, as shown in FIG. 3, which are oriented at angle a to each other. As such, radiation source 108 is configured to emit, through primary collimator 116, two sets of X-ray beams 136, 138 each including X-ray pencil primary beams 102, from each focus point 130 of radiation source 108. Each pencil beam 134 of first X-ray beams 136 is directed at convergence points within first plane 104, and each pencil beam 134 of a second X-ray beams 138 is directed at convergence points within second plane 106.

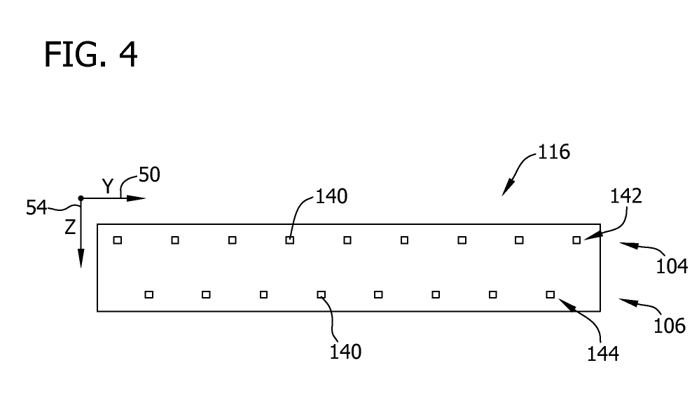

FIG. 4 is a schematic view, in a Y-Z plane, of primary collimator 116. Primary collimator 116 includes a plurality of apertures 140 defined therethrough. Apertures 140 are positioned in a first row 142 and a second row 144. Each aperture 140 forms a pencil beam 134 as a primary beam 102. First row 142 and second row 144 each extend lengthwise along Y-axis 50, or with respect to a length of primary collimator 116. In the exemplary embodiment, first row 142 of apertures 140 is substantially parallel to second row 144 of apertures 140, and spaced apart from each other in a widthwise direction along Z-axis 54. More specifically, a line along which first row 142 of apertures 140 is aligned is substantially parallel to a line along which second row 144 of apertures 140 is aligned, and apertures 140 are spaced apart with respect to a width of primary collimator 116. The widthwise spacing of first row 142 and second row 144 positions first row 142 within first plane 104 and second row 144 within second plane 106. As such, first row 142 of apertures 140 forms first X-ray beams 136 in first plane 104, and second row 144 of apertures 140 forms second X-ray beams 138 in second plane 106.

In the exemplary embodiment, apertures 140 in first row 142 are staggered from apertures 140 in second row 144. More specifically, each aperture 140 in first row 142 is offset in a lengthwise direction from adjacent apertures 140 in second row 144 to produce a staggered arrangement of apertures 140. As such, every other primary beam 102 is in the same plane, and every adjacent primary beam 102 is in a different plane. The staggered arrangement of the exemplary embodiment facilitates reducing cross-talk between primary beams 102

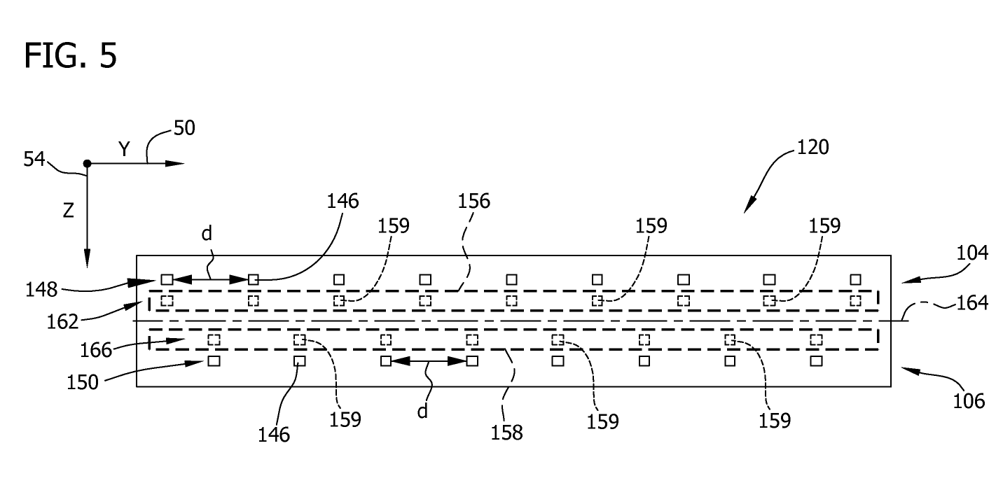

Transmission detector 120 includes a plurality of transmission detector elements 146 configured to receive primary beams 102. More specifically, as shown in FIG. 5, transmission detector 120 includes a first row 148 of transmission detector elements 146 and a second row 150 of transmission detector elements 146. Each transmission detector element 146 is configured to detect or receive a respective primary beam 102. First row 148 and second row 150 each extend lengthwise along Y-axis 50. In the exemplary embodiment, first row 148 of transmission detector elements 146 is substantially parallel to second row 150 of transmission detector elements 146, and spaced apart from each other in a widthwise direction along Z-axis 54. The widthwise spacing of first row 148 and second row 150 positions first row 148 within first plane 104 and second row 150 within second plane 106. As such, first row 148 of transmission detector elements 146 detects or receives first X-ray beams 136 in first plane 104, and second row 150 of transmission detector elements 146 detects or receives second X-ray beams 138 in second plane 106. Further, each transmission detector element 146 in first row 148 is spaced apart by a distance d, and each transmission detector element 146 in second row 150 is spaced apart by distance d. In the exemplary embodiment, distance d is about two times a distance between transmission detector elements in a conventional detection system having primary beams in one plane. Alternatively, distance d may be any suitable distance that enables detection system 100 to function as described herein.

In the exemplary embodiment, transmission detector elements 146 in first row 148 are staggered from transmission detector elements 146 in second row 150 to substantially match a configuration of apertures 140 of primary collimator 116. More specifically, each transmission detector element 146 in first row 148 is offset in a lengthwise direction from adjacent transmission detector elements 146 in second row 150 to produce a staggered arrangement of transmission detector elements 146. The staggered arrangement of the exemplary embodiment facilitates reducing cross-talk between primary beams 102.

Referring again to FIGS. 1-3, a portion of the X-ray radiation from each primary beam 102 typically is scattered in various directions upon contact with object 114 in examination area 110. Secondary collimator 118 is configured to facilitate ensuring that a portion of scattered radiation arriving at scatter detector 122 has a constant scatter angle θ with respect to the corresponding primary beam 102 from which the scattered radiation originated. Secondary collimator 118 is a fixed angle secondary collimator (FASC) and is positioned between examination area 110 and scatter detector 122. In the exemplary embodiment, at least one secondary collimator 118 is configured to collimate scattered radiation 152 from first X-ray beams 136 at scatter angle θ and to collimate scattered radiation 154 from second X-ray beams 138 at scatter angle θ. In a particular embodiment, a first secondary collimator collimates scattered radiation 152 from first X-ray beams 136, and a second secondary collimator collimates scattered radiation 154 from second X-ray beams 138.

Scatter detector 122 includes at least one scatter detector module. In the exemplary embodiment, scatter detector 122 includes one scatter detector module for each plane of primary beams 102. More specifically, scatter detector 122 includes a first scatter detector module 156 configured to receive scattered radiation 152 from first X-ray beams 136 and a second scatter detector module 158 configured to receive scattered radiation 154 from second X-ray beams 138. Each scatter detector modules 156 and 158 includes a plurality of scatter detector elements 159 as described in more detail below.

First scatter detector module 156 is not positioned within first plane 104, and second scatter detector module 158 is not positioned within second plane 106. In the exemplary embodiment, first scatter detector module 156 is spaced apart in the widthwise direction along Z-axis 54 from second scatter detector module 158. Further, first scatter detector module 156 is at an angle γ to second scatter detector module 158. Angle γ is dependent of a number of planes and a value of angle α. For example, for the bi-plane geometry illustrated in FIG. 2, γ=2(θ−(α/2)). A support 160 is coupled to first scatter detector module 156 and second scatter detector module 158 to fix the positions of first scatter detector module 156 and second scatter detector module 158 relative to each other and other components of detection system 100. Alternatively, first scatter detector module 156 and second scatter detector module 158 are in direct contact with each and do not include support 160 therebetween.

In the exemplary embodiment, first scatter detector module 156 and second scatter detector module 158 are positioned between transmission detector elements 146 in first plane 104 and transmission detector elements 146 in second plane 106, as shown in FIGS. 3 and 5. In an alternative embodiment, rather than being positioned between first plane 104 and second plane 106 as shown in FIGS. 3 and 5, first scatter detector module 156 is positioned outside of first plane 104 and/or second scatter detector module 158 is positioned outside of second plane 106. In such a configuration, support 160 is not necessary to couple first scatter detector module 156 and second scatter detector module 158 together. Moreover, although one scatter detector module 156 or 158 is shown for each set of X-ray beams 136 or 138, two scatter detector modules may receive scattered radiation from each set of X-ray beams 136 and/or 138. For example, a scatter detector module may be positioned on each side of a first plane 104 and/or a second plane 106 to detect scattered radiation from a respective set of X-ray beams 136 and/or 138. However, it should be understood that a detector module is positioned such that the detector module only records scatter from primary beams of one plane.

Referring to FIG. 5, in the exemplary embodiment, a scatter detector element 159 is positioned adjacent each transmission detector element 146. Scatter detector elements 159 illustrate in FIG. 5 represent a position of each scatter detector element 159 in relation to each transmission detector element 146 and are shown in dashed lines as not being a part of transmission detector 120. Exactly where scatter detector element 159 will be positioned with respect to a respective transmission detector element 146 depends on angle α. In the exemplary embodiment, scatter detector elements 159 of first scatter detector module 156 are positioned in a first row 162 between first row 148 of transmission detector elements 146 and a longitudinal axis 164 of transmission detector 120. Similarly, scatter detector elements 159 of second scatter detector module 158 are positioned in a second row 166 between second row 150 of transmission detector elements 146 and longitudinal axis 164 of transmission detector 120. Accordingly, scatter detector elements 159 are configured in a staggered arrangement similar to the staggered arrangement of transmission detector elements 146. As such, detection system 100 includes scatter detector 122 having first row 162 of scatter detector elements 159 and second row 166 of scatter detector elements 159 such that first row 162 of scatter detector elements 159 detects scattered radiation 152 from first plane 104 and second row 166 of scatter detector elements 159 detects scattered radiation 154 from second plane 106.

Referring to FIGS. 1-5, when, for example, but not by way of limitation, a twenty-five (25) beam MIFB topology is used in detection system 100, thirteen (13) beams will lie in one plane and twelve (12) beams will lie in the other plane. Because the two scatter detector modules 156 and 158 are faced towards respective primary X-ray beams 136 or 138 and away from each other by being oriented at angle γ, there is little to no chance for a first X-ray beam 136 in first plane 104 to excite a cross-talk scatter ray that irradiates a transmission detector element 146 receiving a second X-ray beam 138 in second plane 106. Further, distance d between adjacent transmission detector elements 146 in first plane 104 or second plane 106 is, in the exemplary embodiment, double that of a distance in a detection system having a conventional MIFB topology. Hence, a cross-talk scatter angle is also approximately doubled. From Equation 1, the photon energy for a certain momentum transfer varies in inverse proportion to scatter angle θ, in a low angle approximation. As such, doubling the cross-talk scatter angle halves the photon energy, which becomes sufficiently small to enable cross-talk photons to most likely be absorbed in object 114.

For example, in a conventional MIFB topology having twenty-five (25) beams, an inter-detector spacing distance is typically 100 millimeters (mm). In detection system 100 having a dual plane high fidelity (Hi Fi) topology, distance d is approximately 200 mm. Generally, in the conventional MIFB system, near detector crossing points of a multiplicity of inverse fan beams are chosen to lie on a line somewhat below conveyor belt at or slightly below a top edge of a secondary collimator. Such an arrangement requires that all scatter detector modules 156 and 158 must share one continuous FASC in a Y-direction. In contrast, in detection system 100 having the dual plane MIFB topology, an inter-detector spacing distance d for transmission detector elements 146 belonging to a certain plane is doubled relative to that of a system having conventional MIFB. Hence, near detector crossing points 133 of a multiplicity of inverse fan beams 132 of detection system 100 lie within examination area 110 and above top edge 135 of FASC 118. This implies that each scatter detector module 156 and 158 may have a dedicated FASC 118 that is more compact and, thus, easier to manufacture than the common FASC of the conventional MIFB system.

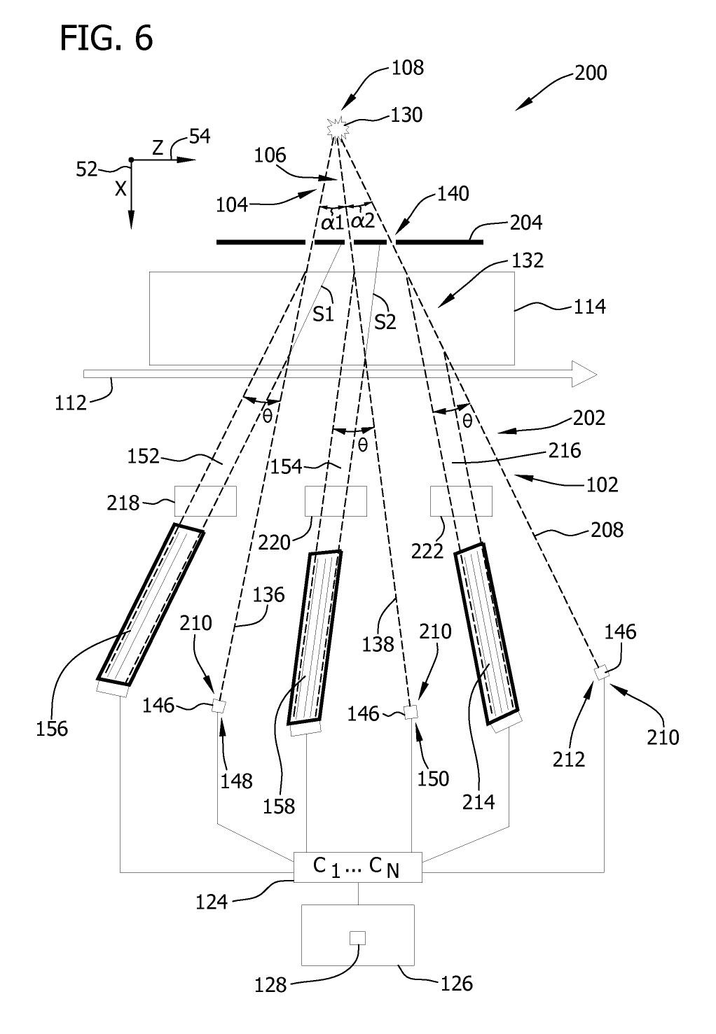

FIG. 6 is a schematic view, in an X-Z plane, of an alternative detection system 200. Detection system 200 includes at least components similar to the components of detection system 100 (shown in FIGS. 1-5) as described above. As such, similar components are labeled with similar references. Detection system 200 includes primary beams 102 in three planes, rather than in two planes. More specifically, detection system 200 includes primary beams 102 in first plane 104, second plane 106, and a third plane 202. First plane 104 is at an angle α1 to second plane 106, and second plane 106 is at an angle α2 to third plane 202. Angle α1 and angle α2 are selected such that a scatter detector module cannot receive radiation from more than one primary beam.

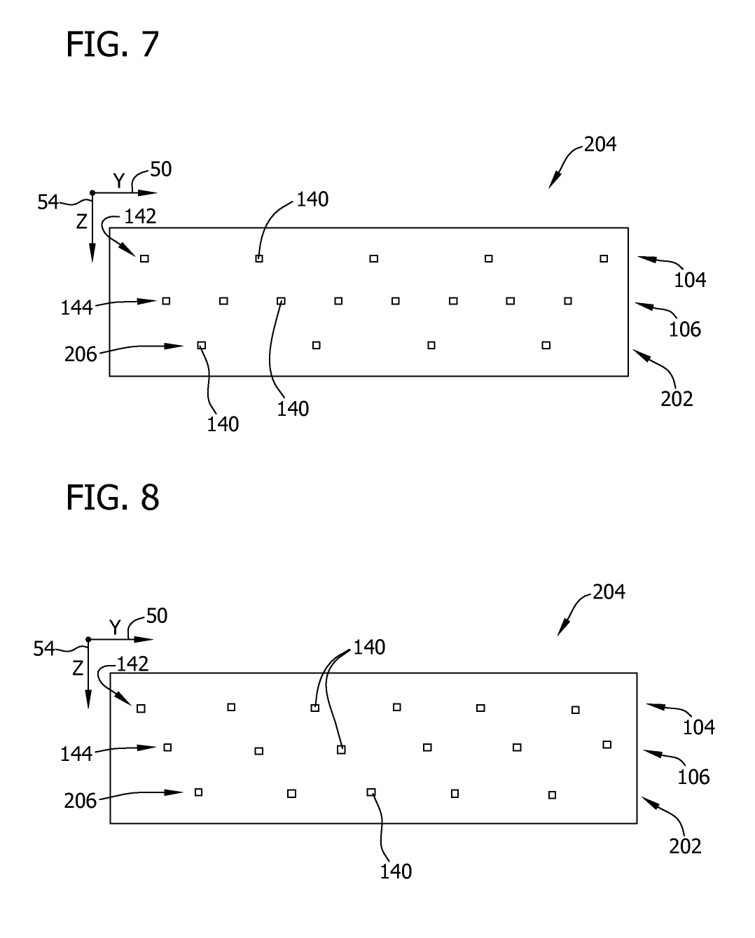

In the exemplary embodiment, a primary collimator 204 includes first row 142 of apertures 140, second row 144 of apertures 140 and a third row 206 of apertures 140. As shown in FIGS. 7 and 8, apertures 140 in each row 142, 144, or 206 are offset in the lengthwise direction from apertures 140 in any other row 142, 144, or 206. Third row 206 is positioned within third plane 202. As such, primary collimator 204 forms first X-ray beams 136 in first plane 104, second X-ray beams 138 in second plane 106, and third X-ray beams 208 in third plane 202.

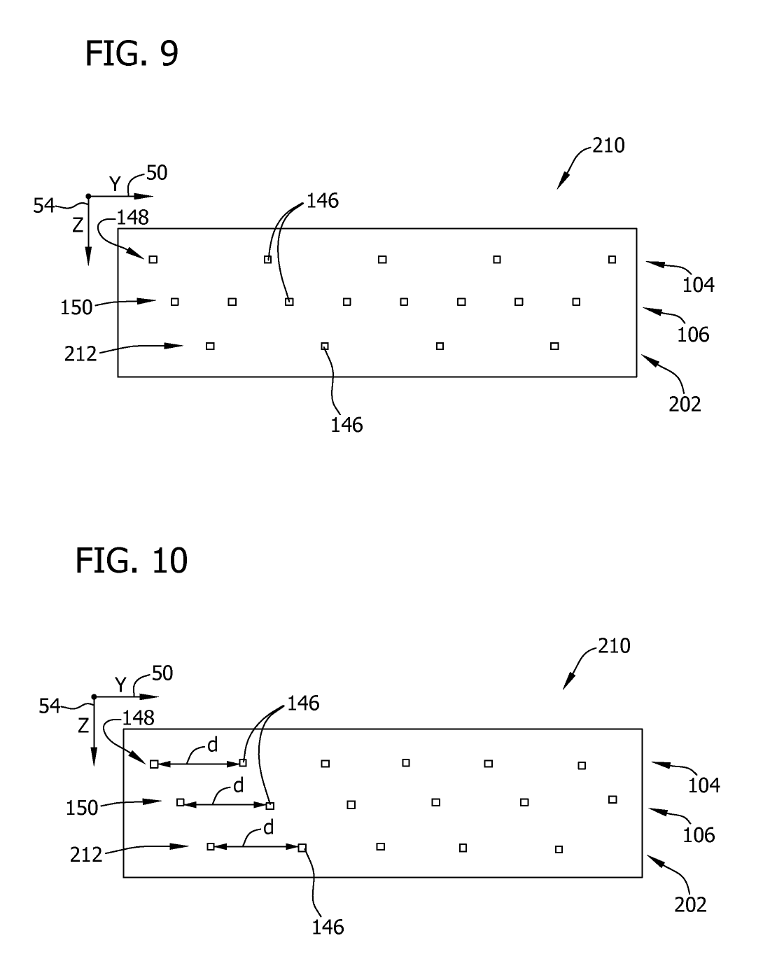

Similarly, as shown in FIGS. 9 and 10, a transmission detector 210 includes first row 148 of transmission detector elements 146, second row 150 of transmission detector elements 146, and a third row 212 of transmission detector elements 146. Third row 212 is positioned within third plane 202. In the exemplary embodiment, transmission detector elements 146 in first row 148 are configured to detect or receive first X-ray beams 136, transmission detector elements 146 in second row 150 are configured to detect or receive second X-ray beams 138, and transmission detector elements 146 in third row 212 are configured to detect or receive third X-ray beams 208. More specifically, transmission detector elements 146 are positioned in an arrangement to correspond to the arrangement of apertures 140 of primary collimator 204. For example, when primary collimator 116 as shown in FIG. 7 is used within detection system 200, transmission detector 210 as shown in FIG. 9 is also used within detection system 200. Further, when primary collimator 204 as shown in FIG. 8 is used within detection system 200, transmission detector 210 as shown in FIG. 10 is also used within detection system 200.

Referring to FIG. 6, detection system 200 further includes at least one scatter detector 122 configured to detect radiation scattered by an interaction of primary beams 102 with object 114. More specifically, scatter detector 122 includes first scatter detector module 156, second scatter detector module 158, and a third scatter detector module 214. First scatter detector module 156 is configured to receive scattered radiation 152 from first X-ray beams 136, second scatter detector module 158 is configured to receive scattered radiation 154 from second X-ray beams 138, and third scatter detector module 214 is configured to receive scattered radiation 216 from third X-ray beams 208. Scatter detector 122 includes scatter detector elements 159 (shown in FIG. 5) that are positioned adjacent transmission detector elements 146 as shown in FIGS. 7-10, and as described above with respect to FIG. 5. As such, detection system 200 includes scatter detector 122 having first row 162 of scatter detector elements 159, second row 166 of scatter detector elements 159, and a third row of scatter detector elements 159 such that first row 162 of scatter detector elements 159 detects scattered radiation 152 from first plane 104, second row 166 of scatter detector elements 159 detects scattered radiation 154 from second plane 106, and the third row of scatter detector elements 159 detects scattered radiation 216 from third plane 202.

At least one secondary collimator collimates scattered radiation before the scattered radiation is received at a scatter detector module. More specifically, in the exemplary embodiment, detection system 200 includes a first secondary collimator 218 to collimate scattered radiation 152 at scatter angle θ, a second secondary collimator 220 to collimate scattered radiation 154 at scatter angle θ, and a third secondary collimator 222 to collimate scattered radiation 216 at scatter angle θ. Although each set of a scatter detector module and a secondary collimator is shown as being positioned on a left side a respective set of X-ray beams, it should be understood that any scatter detector module/secondary collimator set may be positioned to a right side of a respective set of X-ray beams. Further, it should be understood that a scatter detector module/secondary collimator set may be positioned on each side of a respective set of X-ray beams.

In most cases detection system 100 (shown in FIGS. 1-5) sufficiently increases distance d between transmission detector elements 146 lying within the same plane such that inter-detector cross-talk can be ignored. If however, more than, for example, twenty-five (25) primary beams, are desired, and hence a larger scatter signal, detection system 200 (shown in FIG. 6) can be used. The three scatter detector modules are not faced away from one another in detection system 200. In the exemplary embodiment, all scatter detector modules 156, 158, and 214 face the same direction, for example a counter-clockwise direction. In order to inhibit cross-talk, planes 104, 106, and 202 have angular separations such that extreme rays S1 for first scatter detector module 156 and extreme rays S2 for second scatter detector module 158 are blocked by primary collimator 204 from receiving second X-ray beams 138 and third X-ray beams 208, respectively. If first plane 104 and second plane 106 are symmetrically displaced relative to a vertical axis, angle α1 and angle α2 can be calculated.

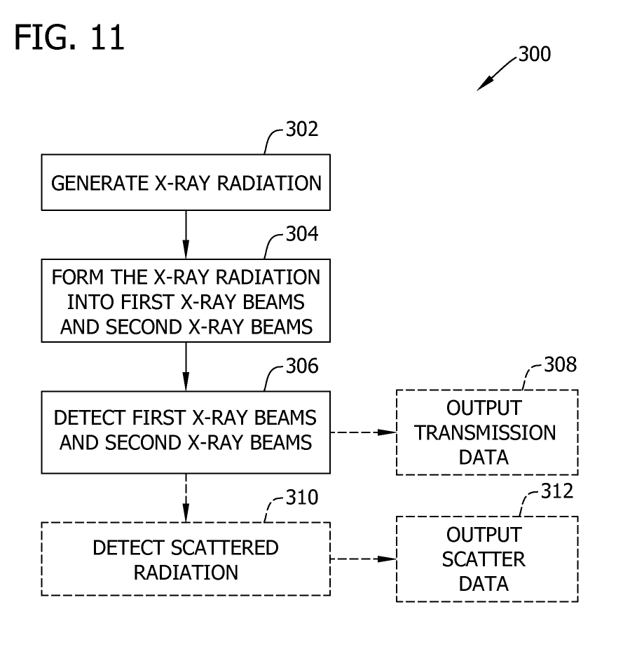

FIG. 11 is a flowchart of an exemplary method 300 that may be used with detection system 100 (shown in FIGS. 1-5) and/or detection system 200 (shown in FIG. 6). By performing method 300, an item and/or a material within object 114 (shown in FIGS. 1-3 and 6) can be detected. For example, method 300 may be used to detect a presence of a contraband item or material within object 114. Method 300 is performed by control system 126 (shown in FIGS. 3 and 6) sending commands and/or instructions to components of detection system 100 and/or detection system 200. Processor 128 (shown in FIGS. 3 and 6) within control system 126 is programmed with code segments configured to perform method 300. Alternatively, method 300 is encoded on a computer-readable medium that is readable by control system 126. In such an embodiment, control system 126 and/or processor 128 is configured to read computer-readable medium for performing method 300. In the exemplary embodiment, method 300 is automatically performed continuously and/or at selected times. Alternatively, method 300 is performed upon request of an operator of detection system 100 and/or 200 and/or when control system 126 determines method 300 is to be performed. For the sake of simplicity, method 300 will be described with respect to detection system 100, however, it should be understood that method 300 can also be used with detection system 200.

Referring to FIGS. 1-5 and 11, method 300 includes generating 302 X-ray radiation from radiation source 108. More specifically, the X-ray radiation is generated 302 from at least one focus point 130 of a multi-focus X-ray source. In a particular embodiment, the X-ray radiation is generated 302 by activating each focus point 130 of radiation source 108 in a sequence and/or in a pattern. Alternatively, or additionally, more than one focus point 130 is activated to generate 302 the X-ray radiation.

The X-ray radiation is formed 304 into first X-ray beams 136 within first plane 104 and second X-ray beams 138 within second plane 106. First X-ray beams 136 and second X-ray beams 138 are considered to be sub-sets of primary beams 102. In the exemplary embodiment, first X-ray beams 136 and second X-ray beams 138 are formed 304 by collimating the X-ray radiation into first X-ray beams 136 using first row 142 of apertures 140 of primary collimator 116 and collimating the X-ray radiation into second X-ray beams 138 using second row 144 of apertures 140 of primary collimator 116. The collimation of primary beams 102 forms first X-ray beams 136 and second X-ray beams 138 such that every other beam is within a same plane and every adjacent beam is in a different plane.

Method 300 further includes detecting 306 first X-ray beams 136 at first row 148 of transmission detector elements 146 of transmission detector 120 and detecting second X-ray beams 138 at second row 150 of transmission detector elements 146 of transmission detector 120. For example, when one focus point 130 is activated, radiation passes through each aperture 140 of primary collimator 116 and is detected 306 at each transmission detector element 146 of transmission detector 120. Transmission detector 120 outputs 308 transmission data based on the detected radiation. The transmission data can be output 308 to any suitable component, including, without limitation, a display device, a reconstruction device, and/or a storage device. The transmission data can be used to reconstruct an image of object 114 and/or items within object 114.

Upon interacting with object 114, first X-ray beams 136 produce scattered radiation 152 and second X-ray beams 138 produce scattered radiation 154. Scattered radiation 152 is detected 310 at first scatter detector module 156, and scattered radiation 154 is detected 310 at second scatter detector module 158. Secondary collimator 118 prevents scattered radiation at an angle other than scatter angle θ from reaching first scatter detector module 156 and second scatter detector module 158. Scatter detector 122 outputs 312 scatter data based on the detected scattered radiation. The scatter data can be output 312 to any suitable component, including, without limitation, a display device, an analysis device, and/or a storage device. The scatter data can be used to perform an X-ray diffraction analysis of object 114 to detect at least one material within object 114.

The embodiments described herein provide a detection system that increases the spacing between detector elements of a transmission detector without decreasing the number of detector elements. More specifically, by providing more than one row of primary collimator apertures, more than one row of detector elements can be used to detect attenuated radiation. For example, by staggering the positions of the apertures and the detector elements, the length and number of detector elements remains the same as in a conventional MIFB system, while increasing the spacing between adjacent detector elements. Further, the multiple rows of apertures and detector elements increase the spacing between detector elements without moving near detector intersection points closer to a radiation source.

Moreover, the embodiments described herein enable a detection system to more easily be manufactured, as compared to convention MIFB system. For example, when an angle between X-ray beam planes is substantially twice a scatter angle, the above-described detection system can be manufactured as one unit with parallel channels for both primary beam planes. Further, the only limitation on the angle between X-ray beam planes, is that the angle should be large enough such that each scatter detector module only detects scatter from a respective primary beam.

A technical effect of the systems and method described herein includes at least one of: (a) generating X-ray radiation from an X-ray source; (b) forming X-ray radiation into first X-ray beams within a first plane and second X-ray beams within a second plane different than the first plane; (c) detecting scattered radiation from first X-ray beams at a first row of scatter detector elements of a scatter detector and scattered radiation from second X-ray beams at a second row of scatter detector elements of the scatter detector; and (d) detecting first X-ray beams at a first row of detector elements of a transmission detector and second X-ray beams at a second row of detector elements of the transmission detector.

Exemplary embodiments of a multiple plane multi-inverse fan-beam detection systems and method for using the same are described above in detail. The method and systems are not limited to the specific embodiments described herein, but rather, components of systems and/or steps of the method may be utilized independently and separately from other components and/or steps described herein. For example, the primary collimator and/or transmission detector may also be used in combination with other X-ray systems and methods, and are not limited to practice with only the X-ray diffraction systems and methods as described herein. Rather, the exemplary embodiment can be implemented and utilized in connection with many other object detection applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A detection system comprising:
a multi-focus radiation source configured to generate X-ray radiation;
a primary collimator defining a first row of apertures and a second row of apertures, the first row of apertures forming first X-ray beams within a first plane from the X-ray radiation and the second row of apertures forming second X-ray beams within a second plane from the X-ray radiation, the first plane different than the second plane; and
a scatter detector comprising a first row of scatter detector elements and a second row of scatter detector elements, the first row of scatter detector elements configured to detect scattered radiation from the first X-ray beams and the second row of scatter detector elements configured to detect scattered radiation from the second X-ray beams.

2. A detection system in accordance with claim 1, wherein a line along which the first row of apertures is aligned is substantially parallel to a line along which the second row of apertures is aligned.

3. A detection system in accordance with claim 1, wherein the first row of apertures is spaced from the second row of apertures with respect to a width of the primary collimator.

4. A detection system in accordance with claim 1, wherein each aperture in the first row of apertures is offset from apertures in the second row of apertures with respect to a length of the primary collimator.

5. A detection system in accordance with claim 1, further comprising a transmission detector comprising a first row of transmission detector elements and a second row of transmission detector elements, the first row of transmission detector elements configured to detect the first X-ray beams and the second row of transmission detector elements configured to detect the second X-ray beams.

6. A detection system in accordance with claim 5, wherein each transmission detector element in the first row of transmission detector elements is offset from transmission detector elements in the second row of transmission detector elements with respect to a length of the transmission detector.

7. A detection system in accordance with claim 1, wherein the first plane is at an angle to the second plane.

8. A detection system in accordance with claim 1 further comprising:
a first scatter detector module configured to detect radiation scattered from the first X-ray beams, the first scatter detector module comprising the first row of scatter detector elements; and
a second scatter detector module configured to detect radiation scattered from the second X-ray beams, the second scatter detector module comprising the second row of scatter detector elements.

9. A detection system in accordance with claim 8 further comprising at least one secondary collimator positioned between the primary collimator and the first scatter detector module and the second scatter detector module, the secondary collimator configured to prevent scatter radiation at an additional angle different than at a predefined angle from being detected by the first scatter detector module and the second scatter detector module.

10. A detection system in accordance with claim 1, wherein
the primary collimator further comprises a third row of apertures configured to form third X-ray beams within a third plane different than the first plane and the second plane; and
the scatter detector further comprises a third row of scatter detector elements configured to detect scattered radiation from the third X-ray beams

11. A detection system in accordance with claim 10, further comprising a transmission detector comprising a first row of transmission detector elements, a second row of transmission detector elements, and a third row of transmission detector elements, wherein the first row of transmission detector elements is configured to detect the first X-ray beams, the second row of transmission detector elements is configured to detect the second X-ray beams, and the third row of transmission detector elements is configured to detect the third X-ray beams.

12. A method for detecting an object, said method comprising:
generating X-ray radiation from a radiation source;
forming the X-ray radiation into first X-ray beams within a first plane and second X-ray beams within a second plane different than the first plane; and
detecting the first X-ray beams at a first row of transmission detector elements of a transmission detector and the second X-ray beams at a second row of transmission detector elements of the transmission detector.

13. A method in accordance with claim 12, further comprising:
detecting scattered radiation from the first X-ray beams at a first scatter detector module comprising a first row of scatter detector elements adjacent to the first row of transmission detector elements; and
detecting scattered radiation from the second X-ray beams at a second scatter detector module comprising a second row of scatter detector elements adjacent to the second row of transmission detector elements.

14. A method in accordance with claim 13, further comprising preventing the scattered radiation from the first X-ray beams and the scattered radiation from the second X-ray beams at an angle other than a predefined scatter angle from reaching the first scatter detector module and the second scatter detector module.

15. A method in accordance with claim 12, wherein generating X-ray radiation from an X-ray source comprises generating a multi-detector inverse fan beam from at least one focus point of a multi-focus X-ray source.

16. A method in accordance with claim 12, wherein forming the X-ray radiation into first X-ray beams within a first plane and second X-ray beams within a second plane comprises:
collimating the X-ray radiation into the first X-ray beams using a first row of apertures of a primary collimator, the first row of apertures within the first plane; and
collimating the X-ray radiation into the second X-ray beams using a second row of apertures of the primary collimator, the second row of apertures within the second plane.

17. A method in accordance with claim 12, wherein a plurality of primary beams comprises the first X-ray beams and the second X-ray beams, and wherein forming the X-ray radiation into first X-ray beams within a first plane and second X-ray beams within a second plane comprises collimating the plurality of primary beams such that every other primary beam is within a same plane and every adjacent primary beam is in a different plane.

18. A method in accordance with claim 12 further comprising:
forming the X-ray radiation into third X-ray beams within a third plane different than the first plane and the second plane;
detecting the third X-ray beams at a third row of transmission detector elements of the transmission detector; and
detecting scattered radiation from the third X-ray beams at a third scatter detector module.

19. A primary collimator for use with an X-ray detection system, said primary collimator defining a first row of apertures within a first plane and a second row of apertures within a second plane different than the first plane, the first row of apertures configured to form first X-ray beams within the first plane and the second row of apertures configured to form second X-ray beams within the second plane.

20. A primary collimator in accordance with claim 19, wherein each aperture in the first row is offset from apertures in the second row with respect to a length of said primary collimator.
